(19) United States
(12) Patent Application Publication
(10) Pub. No.: US 2006/0155861 A1
(43) Pub. Date: Jul. 13, 2006

(54) Communication system and method between a recording and/or reproducing device and a remote unit

(75) Inventors: Darwin He, Shanghai (CN); Declan Patrick Kelly, Eindhoven (NL); Bei Wang, Shanghai (CN); Yang Peng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/525,138

(22) PCT Filed: Aug. 14, 2003
(86) PCT No.: PCT/IB03/03625

§ 371 Date: Feb. 16, 2005

(30) Foreign Application Priority Data
Aug. 21, 2002 (EP) 02292071.4

(51) Int. Cl. G06F 15/16

(52) U.S. Cl. 709/229

(57) ABSTRACT

The present invention relates to a communication and/or reproducing device (20) able to read a data carrier (22) and a remote unit (10) comprising additional data (11) for the data carrier (22). The recording and/or reproducing device (20) and the remote unit (10) communicate via a network (30). The remote unit (10) is able to retrieve data carrier properties (23) from the data carrier (22) inserted in the recording and/or reproducing device (20), and to authenticate said data carrier (22) by comparing said properties (23) with the ones of a corresponding data carrier legally produced by a provider, before sending the additional data (11) to said recording and/or reproducing device (20).

### FIELD OF THE INVENTION

The present invention relates to a communication method via a network between a recording and/or reproducing device able to read a data carrier, and a remote unit comprising additional data for the data carrier.

This invention is particularly relevant for communication of data between a DVD video player and a web site via the Internet network.

### BACKGROUND OF THE INVENTION

The DVD Forum has established a working group AH1-12 to standardize web-connected DVD, as an extension of the current DVD video specification. The principle is that a DVD video disc in accordance with the new specification will be published with links to the publisher's web sites that contain additional data directly related to said specific DVD video disc. The web site can include, for example, new navigation menus, which can be downloaded and used by a DVD video player containing the DVD video disc instead of original menus.

But the content that is published on the web site is not supposed to be accessed and downloaded by everybody. Only the legal DVD video disc owners must be able to access this content and use it while playing the disc.

### SUMMARY OF THE INVENTION

It is an object of the invention to provide a communication method which enables authenticating a data carrier inserted in a recording and/or reproducing device, in order to send additional data only to authenticated data carriers.

To this end, the communication method in accordance with the invention is characterised in that it comprises the steps of:

extracting data carrier properties from the data carrier inserted in the recording and/or reproducing device,

sending said properties to the remote unit, and

authenticating the data carrier by comparing its properties with the ones of a corresponding data carrier legally produced by a provider, before sending the additional data to the recording and/or reproducing device.

Such a communication method is then able to determine if the data carrier, a DVD video disc for example, is a legal copy or not, and then to send the additional data only to a recording and/or reproducing device containing a legal copy.

In a first embodiment, the data carrier properties are written in a control data zone of the data carrier.

Hence, these properties cannot easily be modified by a recording device and can be read by the great majority of reproducing devices.

In another embodiment, the communication method comprises a step of blacklisting the recording and/or reproducing device if the remote unit receives a number of requests higher than a predetermined threshold from the recording and/or reproducing device containing a non-authenticated data carrier.

Thus the communication method is able to refuse further requests from a given recording and/or reproducing device if said device has tried several times to connect with the remote unit while containing each time an illegal data carrier.

The present invention also relates to a communication system comprising a recording and/or reproducing device able to read a data carrier, and a remote unit comprising additional data for the data carrier, said device and unit communicating via a network.

It relates to a remote unit or to a recording and/or reproducing device comprised in said communication system.

It finally relates to a computer program comprising program instructions for implementing the communication method.

These and other aspects of the invention will be apparent from and elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a block diagram showing the communication system in accordance with the invention, and

FIG. 2 is a schematic representation of an arborescence of the storage position of DVD disc properties on a DVD disc.

### DETAILED DESCRIPTION OF THE INVENTION

The present invention relates to a method of communicating data between a recording and/or reproducing device and a remote unit connected to each other via a network. In the following description, the recording and/or reproducing device is a DVD video player, the remote unit is a web site and the network is the Internet.

Nevertheless, it will be obvious to a person skilled in the art that the present invention more generally relates to client/server architecture. On the client side, the recording and/or reproducing device is, for example, a home DVD player or a personal computer DVD player with an Internet connection and a protocol stack built into it, or a GPRS (General Packet Radio Service) or third generation mobile phone equipped with Small Format Factor Optical SFFO discs. On the server side, the remote unit is a computer system having web related services or proxies running on it. The network that connects both sides is any kind of network based on TCP/IP protocol (Transmission Control Protocol/Internet Protocol), for example IPv4 or IPv6 protocol.

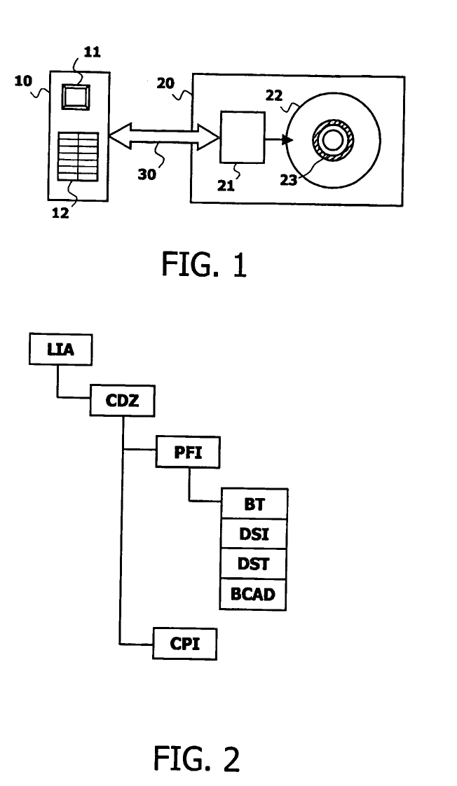

FIG. 1 is a block diagram showing the communication system in accordance with the invention. Said communication system comprises a DVD video player (20) able to read a data carrier (22), and a web site (10) comprising additional data (11) for the data carrier (22).

In our example, the data carrier is a DVD video disc but it will be apparent to a person skilled in the art that the present invention is not limited to DVD discs. The scope of the present invention generally includes any medium having any physical disc format (e.g. CD, DVD, Blu-ray disc, etc.), including Read Only, Recordable, and Rewritable discs. The present invention generally applies to discs that include different application formats (e.g. video, audio, games, etc.).

A publisher is responsible for managing the web site from inputs of a disc provider, the publisher and the provider being the same person or different persons. The DVD video player (20) and the web site (10) communicate via the Internet (30).

The DVD video disc contains links to publisher's web sites. When such a disc is inserted into the DVD video player, customers can combine local DVD video with additional data (11), which are Internet enhanced content directly related to this specific DVD video disc. The Internet enhanced content is, for example, a new version of DVD menus, pictures, audio or subtitles synchronized with local DVD video. DVD disc providers create the Internet enhanced content. The Internet enhanced content is also called enhanced navigation (ENAV) content.

The present invention is based on the indication to the publisher's web site of predetermined disc properties of a disc inserted in the player. This enables said web site to determine if the DVD video disc is an original, and then to permit access to the ENAV content, or an illegal copy, in which case access to the web site is blocked. The predetermined DVD disc properties are chosen among the following properties:
Book type: Read Only (RO), Rewritable (RW), Recordable (R)
Disc size: 12 cm or 8 cm
Number of layers: Single Layer (SL), Double Layer (DL)
Layer type: contains or does not contain rewritable user data area, contains or does not contain recordable user data area, contains or does not contain embossed user data area
Track Path: Parallel Track Path (PTP), Opposite Track Path (OTP)
BCA descriptor: indicates whether the disc has BCA (Burst Cutting Area) or not
Region Management information: region codes from 1 to 6
Copyright type: Disc is or isn't CSS encrypted, or CPPM encrypted for DVD-Audio, or CPRM encrypted for RW discs, where CSS means Content Scrambling System, CPRM means Content Protection for Recordable Media and CPPM means Content Protection for Pre-Recorded Media.

The above properties are located in control data Zone (CDZ) of disc lead-in area (LIA) as shown in FIG. 2. The control data zone comprises firstly physical format information (PFI) such as the book type (BT), the disc size (DSI), the disc structure (DST)—that is to say the number of layers, the layer type and the track path—and the BCA descriptor (BCAD). It comprises secondly content provider information (CPI) such as copyright type and region management information.

A recording device can't easily copy the above-described properties, these items of information being generated by the recorder system automatically. Moreover, all reproducing devices can read said properties. In the preferred embodiment, the web site (10) comprises means for retrieving some of the above-cited disc properties (23) from the DVD video disc (22) inserted in the player (20). It also comprises means for authenticating said DVD video disc (22) by comparing said properties (23) with the ones of a corresponding DVD video disc legally produced by a provider, before sending the additional data (11) to the player (20).

In another embodiment, the player comprises means (21) for extracting disc properties (23) from the DVD video disc (22) inserted in the player (20) and means (21) for sending said properties (23) to the web site (10).

The following paragraph gives a more detailed description of these embodiments. As described above, the DVD video disc contains a link to a publisher's web site or default ENAV content locally. The way of exchanging data between the player and the web site follows the steps below:

When playback starts, the player reads the link and gets connected to the web site. A web page is downloaded and interpreted by the player or local default ENAV content is loaded and interpreted by the player.

A script object based on XHTML, SMIL or ECMAScript language and located inside the web page is executed to read the required disc properties by calling into some low-level Application program Interfaces (APIs). Some examples of APIs, defined for ECMAScript object, are the following:
gets disc layer information, which returns SL or DL,
gets disc book type, which returns RO or RW or R.
   Another option is that the transmission protocol between the player and the web site requires the player to include predetermined information in the request to the web site. In this case the player will read this information and include it in the request to the web site. In this case, it is not necessary to include a script on the disc and to define APIs that the player must support.

After the required disc properties are extracted, said properties are sent to the publisher's web site for authentication in a secured manner. For example, a Uniform Resource Locator (URL) containing the following disc properties is generated: https://www.newline.conwWebDVD/Authentication?movietitle=RushHour?booktype=SL&di scsize=12&regioncode=6.

The transmission protocol is based on Secure Socket Layer (SSL) or HyperText Transfer Protocol Secure (HTTPS) transmission protocol for secured transaction.

If authentication succeeds, permission is granted, for example by generating a secure identifier id valid for one session, and the player can access further ENAV content on the web site during said session. But if the properties are not correct, connection is rejected by the web site, and the player cannot download ENAV content.

Hence, the web site is able to determine from the disc properties if the disc is a valid original or not. For example, if the disc provider produced a specific disc with the following properties: RO, 12 cm, DL, PTP, BCA, region code 2 (Europe/Japan), CSS encrypted, then the disc having the following properties: RW, 8 cm, SL, OTP, no BCA, not CSS encrypted, region code 6, is an illegal disc even if it has the same video content as the original one. It must be noted that the publisher must manage a database containing all the properties of the disc produced by the disc provider for a proper operation of the invention.

Moreover, if the web site receives a number of requests from a player containing illegal discs, then the web site can blacklist the player and refuse to accept further requests from this player, after 5 trials for example.

The above description relates to the use of the disc properties to detect illegal copies of discs. But said properties can also be used for other applications. In a particular embodiment of the invention, the web site is able to send different types of ENAV content depending on the properties of a disc.

For example, the web site in accordance with the invention is able to identify if the disc is a RO, R or RW disc. If the disc is a legal R/RW disc, the web site can then allow the recording device containing the disc to download and store data on the disc. As the network capacities are typically not sufficient for streaming DVD quality video, video data can then be downloaded to an R/RW disc and watched later from said disc.

As another example, the web site in accordance with the invention is able to identify the region code of a disc. The web site may contain advertisements for a predetermined movie, an advertisement depending on the region code of the disc. The web site is then able to send the advertisement corresponding to the movie currently available in a given region.

Any reference sign in the following claims should not be construed as limiting the claim. It will be obvious that the use of the verb “to comprise” and its conjugations do not exclude the presence of any other steps or elements besides those defined in any claim. The word “a” or “an” preceding an element or step does not exclude the presence of a plurality of such elements or steps.

1. A communication method via a network (30) between a recording and/or reproducing device (20) able to read a data carrier (22), and a remote unit (10) comprising additional data (11) for the data carrier (22), said communication method comprising the steps of:
extracting data carrier properties (23) from the data carrier (22) inserted in the recording and/or reproducing device (20),
sending said properties (23) to the remote unit (10), and
authenticating the data carrier (22) by comparing said properties (23) with the ones of a corresponding data carrier legally produced by a provider, before sending the additional data (11) to the recording and/or reproducing device (20).

2. A communication method as claimed in claim 1, wherein the data carrier properties (23) are written in a control data zone of the data carrier (22).

3. A communication method as claimed in claim 1, further comprising a step of blacklisting the recording and/or reproducing device (20) if the remote unit (10) receives a number of requests higher than a predetermined threshold from said recording and/or reproducing device (20) containing a non-authenticated data carrier.

4. A communication method as claimed in claim 1, wherein the remote unit (10) is able to send different types of additional data (11) as a function of the properties (23) of the data carrier (22).

5. A communication system comprising a recording and/or reproducing device (20) able to read a data carrier (22), and a remote unit (10) comprising additional data (11) for the data carrier (22), said device (20) and unit (10) communicating via a network (30), wherein the remote unit (10) is able to retrieve data carrier properties (23) from the data carrier (22) inserted in the recording and/or reproducing device (20), and to authenticate said data carrier (22) by comparing said properties (23) with the ones of a corresponding data carrier legally produced by a provider, before sending the additional data (11) to said recording and/or reproducing device (20).

6. A remote unit (10) for communicating with a recording and/or reproducing device (20) able to read a data carrier (22), the remote unit (10) comprising additional data (11) for the data carrier (22), means for retrieving data carrier properties (23) from the data carrier (22) inserted in the recording and/or reproducing device (20), and means for authenticating said data carrier (22) by comparing said properties (23) with the ones of a corresponding data carrier legally produced by a provider, before sending the additional data (11) to said recording and/or reproducing device (20).

7. A recording and/or reproducing device (20) able to read a data carrier (22) and to communicate with a remote unit (10) comprising additional data (11) for the data carrier (22), said device comprising means for extracting data carrier properties (23) from the data carrier (22) inserted in the recording and/or reproducing device (20) and means for sending said properties (23) to the remote unit (10).

8. A computer program comprising program instructions for implementing, when said program is executed by a processor, a communication method via a network (30) between a recording and/or reproducing device (20) able to read a data carrier (22), and a remote unit (10) comprising additional data (11) for the data carrier (22), said communication method comprising the steps of:
extracting data carrier properties (23) from the data carrier (22) inserted in the recording and/or reproducing device (20), and
sending said properties (23) to the remote unit (10).

9. A computer program comprising program instructions for implementing, when said program is executed by a processor, a communication method via a network (30) between a recording and/or reproducing device (20) able to read a data carrier (22), and a remote unit (10) comprising additional data (11) for the data carrier (22), said communication method comprising the steps of:
retrieving data carrier properties (23) from the data carrier (22) inserted in the recording and/or reproducing device (20), and
authenticating the data carrier (22) by comparing said properties (23) with the ones of a corresponding data carrier legally produced by a provider, before sending the additional data (11) to the recording and/or reproducing device (20).
